(19) United States
(12) Patent Application Publication
(10) Pub. No.: US 2008/0285532 A1
(43) Pub. Date: Nov. 20, 2008

(54) Floor Control for Multimedia Push-To-Talk Applications

(75) Inventor: Philippe Gentric, Fourqueux (FR)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONIC, N.V., EINDHOVEN (NL)

(21) Appl. No.: 10/596,323

(22) PCT Filed: Dec. 3, 2004
(86) PCT No.: PCT/IB2004/004012

§ 371 Date: Jun. 9, 2006

(30) Foreign Application Priority Data
Dec. 11, 2003 (EP) 03300261.9

(51) Int. Cl. H04Q 7/28

(52) U.S. Cl. 370/340

(57) ABSTRACT

The invention relates to a Push-to-Talk application enabling the transmission of different types of content, for example voice content and video content. In Push-to-Talk applications, only one user of a group can talk at a time and a floor control procedure is used to control access to the floor by the users of the group. According to the invention, separate implementations of the floor control procedure are used with the framework of one single session for managing access to the floor for the transmission of different types of content. For example a first implementation of the floor control procedure is used to manage floor access for the transmission of voice content and a second independent implementation of the floor control procedure is used to manage floor access for the transmission of picture content.

### FIELD OF THE INVENTION

The present invention relates to a communication system comprising a plurality of user apparatuses, a communication network, and at least one application server for implementing an application between a group of at least two user apparatuses, said application allowing transmission of at least a first type of content from one user apparatus of said group to the other user apparatus or apparatuses of said group.

The invention also relates to a user apparatus and an application server for use in such a communication system.

The invention also relates to a method of allowing transmission of a first type of content from one user apparatus of a group to the other user apparatus or apparatuses of said group.

The invention has interesting applications in the field of mobile communication, in particular mobile telephony.

### BACKGROUND OF THE INVENTION

Such an application is known as Push-to-Talk on Cellular (PoC). The PoC application is described, for example, in the White Paper “Push-to-Talk over Cellular—Real-time always-on voice service” published by Nokia (http://www.nokia.com/poc/PoC_WP_A4.pdf).

As explained in Nokia's White Paper, PoC is a half-duplex ‘always-on’ one-to-one/one-to-many ‘voice over IP’ communication service implemented in a cellular network. The PoC service operates as follows: users can create talk groups; within a group, only one user can speak at a time; the floor is requested by pushing a dedicated key and it is granted on a first-come, first-served basis.

Usually, the mechanism that arbitrates the users' requests for the right to speak is referred to as “floor control” and an established connection between user apparatuses where the PoC service is implemented is referred to as a “session”.

As mentioned in Nokia's White Paper, text chat can be added to the real-time voice communication. Unlike voice, text chat does not require any floor control mechanism. All user apparatuses can send text at any moment. The received text is displayed on-screen in received order with history: there is no floor conflict.

It is one of the objects of the present invention to propose an extension of such a service in the specific case where several types of content are transmitted that require a floor control mechanism.

### SUMMARY OF THE INVENTION

A communication system according to the invention is defined in claims 1 to 3. A user apparatus according to the invention is defined in claims 4 to 6. An application server according to the invention is defined in claims 7 to 9. A method according to the invention is defined in claim 10.

According to the invention, when at least two types of content are transmitted, separate floor control procedures are implemented for controlling the floor access for each of said two types of content. As a result, a first user apparatus of the group can have the floor at a given time for transmitting said first type of content to the other apparatus or apparatuses of the group, and a second user apparatus of the same group can have the floor at the same time for transmitting said second type of content to the other user apparatuses of the group. The first and the second user apparatus may be two different user apparatuses.

The invention allows transmission of different types of content by different user apparatuses in a single session. For example, the invention allows transmission of video from a user apparatus A to the group, and simultaneous comments by any other user apparatus of the group to the group (including user A). For example, when the transmitted video is a live video captured by a camera incorporated in the user apparatus A, a user B may provide voice comments relating to camera guidance (please turn left/right; could you zoom in on that please . . . ).

In a preferred embodiment, the floor control mechanism is based on a request/grant protocol implemented between the application server and the user apparatuses.

### BRIEF DESCRIPTION OF THE DRAWINGS

These and other aspects of the invention will be further described with reference to the following drawings:

FIG. 1 is a schematic representation of a first example of a system according to the invention;

FIG. 2 is a block diagram of an application server according to the invention;

FIG. 3 is a schematic representation of a second example of a system according to the invention;

FIG. 4 is a block diagram of a user apparatus according to the invention;

FIG. 5 is a schematic representation of a method according to the invention, comprising several independent implementations of a floor control procedure for the transmission of several types of content.

### DESCRIPTION OF EMBODIMENTS

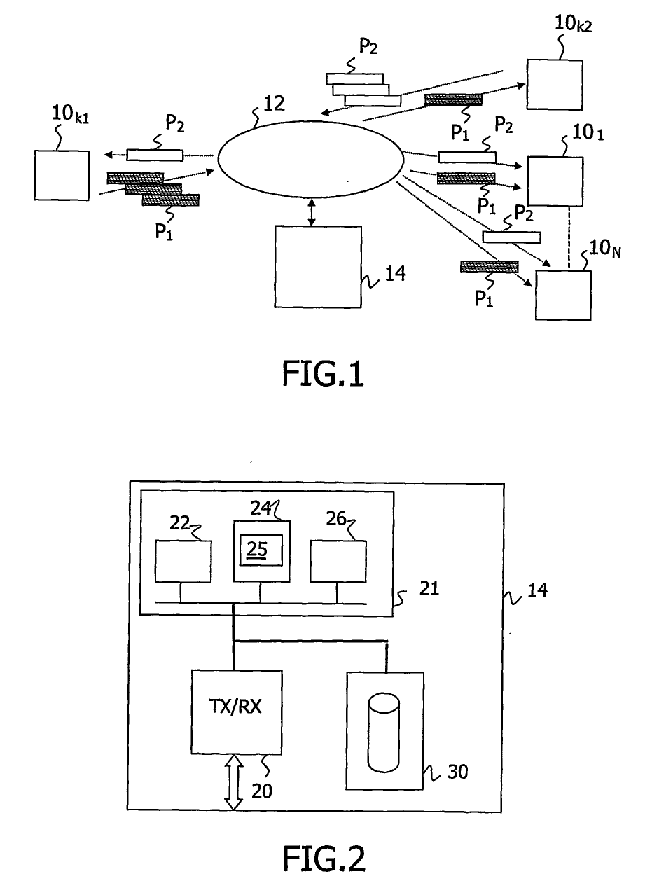

FIG. 1 is a schematic representation of a system comprising a plurality of user apparatuses 10; (i is an integer), a communication network 12, and at least one application server 14. For example, the user apparatuses are mobile phones, and the network 12 is a cellular network, for example, a GPRS network or a UMTS network. The application server is responsible for implementing a communication application between a group of user apparatuses 10; (i=1, . . . , N with N>1). According to the invention, this application allows transmission of at least:

a first type of content (for example, voice content) from one user apparatus 10_{q1} to the other user apparatuses of the group 10ᵢ (i=1, . . . , N; i≠q1), and

a second type of content (for example, still or moving pictures content) from one user apparatus 10_{q}2 to the other user apparatuses of the group 10ᵢ (i1, . . . , N; i≠q2).

The transport protocol is RTP over UDP over IP, which means that the content (previously encoded) is transported in the payload of a RTP packet, the RTP packet being transported as the payload of a UDP datagram which in turn is transported as the payload of an IP packet (RTP is defined in IETF RFC1889; UDP is defined in IETF RFC 768).

In FIG. 1, the first and the second type of content are transmitted in IP packets P₁ and P₂, respectively.

As shown in FIG. 2, the application server 14 comprises:

transmission/reception means 20 for transmitting/receiving IP packets over the network 12;

a processing unit 21 comprising a processor 22, a program memory 24 for storing one or more programs 25 comprising instructions for implementing the above-mentioned communication application when executed by the processor 22, and a data memory 26 for storing data;

a database of user information 30 comprising IP address and group membership as well as other information such as subscribed services/applications, rights, profiles, etc.

In a first alternative embodiment not represented here, the database 30 is hosted on another device designed to communicate with the application server 14.

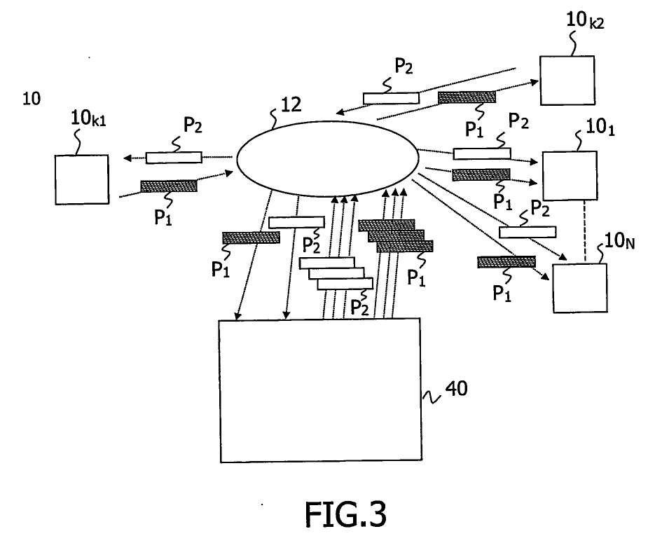

In a second alternative embodiment represented in FIG. 3, a duplicator 40 is used, which receives the IP packets from the user apparatus having the floor and duplicates the RTP payloads towards the other user apparatuses of the group. The duplicator 40 can be hosted either by the application server 14 or by another device in the network.

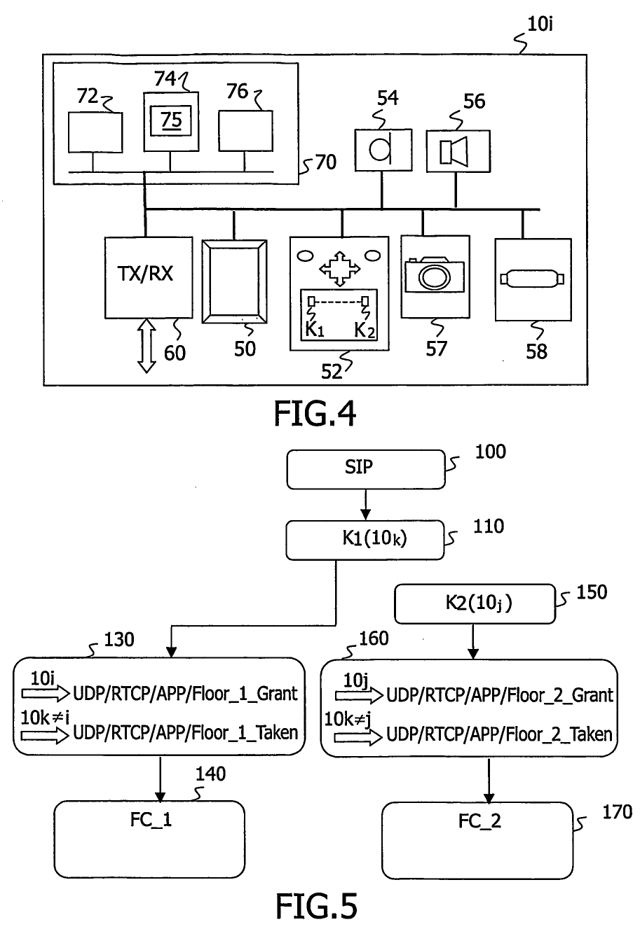

As shown in FIG. 4, a user apparatus 10; according to the invention comprises:

a screen 50, a keyboard 52, a microphone 54, a loudspeaker 56, a camera 57 and a power supply 58;

a transmission/reception circuit 60 for transmitting/receiving IP packets over the network 12;

a processing unit 70 comprising a processor 72, a program memory 74 for storing one or more programs 75 comprising instructions for implementing the above-mentioned communication application when executed by the processor 72, and a data memory 76 for storing data.

The user apparatus of FIG. 4 has a first and a second dedicated key K₁ and K₂ to be activated in order to request the floor for the transmission of the first and the second type of content, respectively. In FIG. 4, the keys K₁ and K₂ are hard keys. In an alternative embodiment not represented here, the dedicated keys K₁ and K₂ are soft keys.

In particular, the programs 25 and 75 comprise instructions for managing sessions and instructions for implementing a floor control procedure for each session.

For example, the session is established and managed by using the IETF-defined Session Initiation Protocol (SIP). In particular, the SIP protocol allows group creation and attachment control, negotiating the codec to be used during the session for each type of content, and determining the IP addresses and the UDP ports to be used for the transport of the RTP packets during the session.

Use of the SIP protocol is not mandatory; other alternative protocols could be used instead of SIP.

The floor control is an arbitration process that is used for allocating the floor to one user apparatus at a time during a session. An example of such a floor control procedure for voice content is described in the Technical Specification “Push-to-Talk over Cellular (PoC) User Plane; Transport Protocols. PoC Release 1.0” dated August 2003 by Ericsson, Motorola, Nokia and Siemens (http://www.ericsson.com/multiservicenetworks/distr/PoC_specifications.ZIP).

The floor control procedure described in this Technical Specification comprises the transmission/reception of floor control messages between the application server 14 and the user apparatuses 10ᵢ for implementing the following floor control protocols:

Floor Request/Grant at session initiation;

Floor Request/Grant during session;

Floor Release;

Floor Revoke.

The floor control messages defined in this Technical Specification are:

Floor Idle: notification by the application server that no user apparatus has the floor so that the floor is available upon user request;

Floor Release: notification by the user apparatus to the application server that it is releasing the floor;

Floor Request: request by the user apparatus to the application server in order to get access to the floor;

Floor Grant: notification by the application server to the user apparatus that it has been granted the floor;

Floor Taken: notification by the application server to all user apparatuses, except the user apparatus that has been granted the floor, that the floor has been granted to another user apparatus;

Floor Deny: notification by the application server to a user apparatus that it has been denied the floor;

Floor revoke: notification by the application server to the user apparatus having the floor that it is revoked (used for pre-emption or for preventing overly long use by one user apparatus).

The floor control messages are transported through UDP in a RTCP APP payload (RTCP stands for RTP Control Protocol; it is defined in IETF RFC1889; APP packets are Application-defined RTCP packets).

More details about these floor control protocols and floor control messages can be found in the above-mentioned Technical Specification.

Use of the floor control procedure defined in the above-mentioned Technical Specification is not mandatory; other alternative procedures could be used instead.

According to the present invention, separate implementations of such a floor control procedure are used for managing access to the floor for the transmission of different types of content. For example, a first implementation of the floor control procedure is used to manage floor access for the transmission of voice, and a second separated implementation of the same floor control procedure is used to manage floor access for the transmission of video content.

With the invention, several implementations of the floor control procedure are used separately within the framework of a single SIP session for managing access to the floor for different types of content. This means that the session has to be established only once. During the session establishment:

the group is constituted (members are selected by the user who is initiating the session; invitations are transmitted to the selected members; selected members accept or do not accept the invitation; members who accept the invitation are added to the group), and

a configuration is defined for each type of content that may be transmitted during the session (for example, an audio codec is defined as well as a video format and a video codec).

FIG. 5 is a schematic representation of an example of a method according to the invention, comprising two independent implementations of a floor control procedure for the transmission of two types of content.

In step 100, a user apparatus 10ᵢ initiates a SIP session. For example, the session is initiated through the menu of the user apparatus 10ᵢ. In step 110, key K₁ of a user apparatus 10ₖ of the group is depressed for the transmission of a first type of content C₁. In step 130, a first implementation FC_1 of the floor control procedure is initiated by transmitting an UDP/RTCP/APP/Floor_Grant message from the application server 14 to the user apparatus 10ₖ and an UDP/RTCP/APP/Floor_Taken message to the other user apparatuses of the group. Upon reception of the Floor_Grant message, the user apparatus 10ₖ can start transmitting content of type C₁. In step 140, the floor control procedure FC_1 is executed as described above for managing access to the floor by all user apparatuses for the transmission of content of type C₁.

In step 150, key K₂ of a user apparatus 10ⱼ belonging to the same group is depressed for the transmission of a second type of content C₂ (the user apparatus 10ⱼ may be any user apparatus of the group including user apparatus 10ᵢ). In step 160, a second implementation FC_2 of the floor control procedure is initiated by transmitting an UDP/RTCP/APP/Floor_Grant message from the application server 14 to the user apparatus 10ⱼ and an UDP/RTCP/APP/Floor_Taken message to the other user apparatuses of the group. Upon reception of the Floor_Grant message, the user apparatus 10ⱼ can start transmitting content of type C₂. In step 170, the floor control procedure FC_2 is executed as described above for managing access to the floor by all user apparatuses for the transmission of content of type C₂.

With respect to the above-described system, user apparatus, application server and method, modifications or improvements may be proposed without departing from the scope of the invention. The invention is thus not limited to the examples provided.

The number of separated implementations of the floor control procedure is not restricted to two. For example, the communication application could allow transmission of data in addition to voice and moving pictures, and a third implementation of the floor control procedure could be implemented to manage floor access for the transmission of data. The number of separate implementations of the floor control procedure is generally dependent on the number of different types of content to be transmitted in the application.

The invention is not limited to the use of the transport and session initiation protocols mentioned in the description (UDP, RTP, RTCP, SIP). Alternative protocols may be used.

The floor control protocols and messages mentioned in the description are those that have been proposed in the Technical Specification “Push-to-Talk over Cellular (PoC) User Plane; Transport Protocols. PoC Release 1.0” of August 2003. Different messages and protocols could be used. Additional messages could be defined.

The user apparatus and the application server may comprise elements other than those described with reference to FIG. 2 and FIG. 3.

Use of the verb “comprise” and its conjugations in the text and claims does not exclude the presence of means or steps other than those stated.

Use of the article “a” or “an” for designating an element does not exclude the presence of a plurality of such elements.

1. A communication system comprising a plurality of user apparatuses, a communication network and at least one application server for implementing an application between a group of at least two user apparatuses, said application allowing transmission of at least a first type of content from one user apparatus of said group to the other user apparatus or apparatuses of said group and a second type of content from one user apparatus of said group to the other user apparatus or apparatuses of said group, said user apparatuses and said application server comprising user floor control means and server floor control means, respectively, for separately managing floor access by said user apparatuses for the transmission of said first type of content and said second type of content, such that only one user apparatus can have the floor at a given time for transmitting said first type of content, and only one user apparatus can have the floor at the same time for transmitting said second type of content.

2. A communication system as claimed in claim 1, wherein said user floor control means comprise means for transmitting/receiving floor control messages to/from said application server, and said server floor control means comprise means for transmitting/receiving floor control messages to/from said user apparatuses so as to implement a request/grant protocol.

3. A communication system as claimed in claim 1, wherein said first type of content is voice content and said second type of content is picture content.

4. A user apparatus for use in a communication system comprising a plurality of user apparatuses, a communication network and at least one application server for implementing an application between a group of at least two user apparatuses, said application allowing transmission of at least a first type of content from one user apparatus of said group to the other user apparatus or apparatuses of said group and a second type of content from one user apparatus of said group to the other user apparatus or apparatuses of said group, said user apparatus comprising user floor control means intended to cooperate with said application server for separately managing floor access by said user apparatuses for the transmission of said first type of content and said second type of content, such that only one user apparatus can have the floor at a given time for transmitting said first type of content, and only one user apparatus can have the floor at the same time for transmitting said second type of content.

5. A user apparatus as claimed in claim 4, wherein said user floor control means comprise means for transmitting/receiving floor control messages to/from said application server so as to implement a request/grant protocol.

6. A mobile telephone as claimed in claim 4, comprising a camera for capturing moving pictures, a first key for requesting the floor for transmitting said moving pictures, and a second key for requesting the floor for transmitting voice.

7. An application server for use in a communication system comprising a plurality of user apparatuses, a communication network and at least one application server for implementing an application between a group of at least two user apparatuses, said application allowing transmission of at least a first type of content from one user apparatus of said group to the other user apparatus or apparatuses of said group and a second type of content from one user apparatus of said group to the other user apparatus or apparatuses of said group, said application server comprising server floor control means intended to cooperate with said user apparatuses for separately managing floor access by said user apparatuses for the transmission of said first type of content and said second type of content, such that only one user apparatus can have the floor at a given time for transmitting said first type of content, and only one user apparatus can have the floor at the same time for transmitting said second type of content.

8. An application server as claimed in claim 7, wherein said server floor control means comprise means for transmitting/receiving floor control messages to/from said user apparatuses so as to implement a request/grant protocol.

9. An application server as claimed in claim 7, wherein said first type of content is voice content and said second type of content is picture content.

10. A method of allowing transmission of a first type of content from one user apparatus of a group to the other user apparatus or apparatuses of said group and a second type of content from one user apparatus of said group to the other user apparatus or apparatuses of said group, said method comprising a first implementation of a floor control procedure for managing floor access by said user apparatuses for the transmission of said first type of content and a second implementation of said floor control procedure for managing floor access by said user apparatuses for the transmission of said second type of content, such that only one user apparatus can have the floor at a given time for transmitting said first type of content, and only one user apparatus can have the floor at the same time for transmitting said second type of content.
